(19) United States
(12) Patent Application Publication
(10) Pub. No.: US 2013/0158952 A1
(43) Pub. Date: Jun. 20, 2013

(54) SYSTEM AND METHOD FOR LIGHTING OPTIMIZATION

(71) Applicant: The Lighting Partnership, Inc., West Palm Beach, FL (US)

(72) Inventors: BRIAN LIEBEL, West Palm Beach, FL (US); RITA LEE, West Palm Beach, FL (US)

(73) Assignee: THE LIGHTING PARTNERSHIP, INC, West Palm Beach, FL (US)

(21) Appl. No.: 13/709,307

(22) Filed: Dec. 10, 2012

Related U.S. Application Data
(60) Provisional application No. 61/576,463, filed on Dec. 16, 2011.

(51) Int. Cl. G06F 15/00

(52) U.S. Cl. CPC G06F 15/00
USPC 702/182

(57) ABSTRACT

In an embodiment in accordance with the present invention, a method for determining a series of alternative lighting systems having reduced energy usage over a baseline lighting system comprises determining and presenting a series of alternative lighting systems. The method receives an identification of a plurality of baseline components of the baseline lighting system and calculates estimates of performance characteristics of the baseline lighting system based on specified performance characteristics of the identified baseline components. The series of alternative lighting systems is then determined based on the estimates of performance characteristics of the baseline lighting system. Each alternative lighting system includes a plurality of mutually compatible components obtained from a database specifying performance characteristics for a plurality of components including the mutually compatible components. The series of alternative lighting systems are presentable hierarchically based on at least one of energy usage, economic criteria, and rated life.

### CLAIM OF PRIORITY

This application claims priority from the following co-pending application, which is hereby incorporated in its entirety: U.S. Provisional Application No. 61/576,463 entitled: “SYSTEM AND METHOD FOR LIGHTING OPTIMIZATION”, by Liebel, et al., filed Dec. 16, 2011.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to systems and methods for lighting optimization.

### BACKGROUND OF THE INVENTION

There are presently five general classifications of lighting design systems and methods for computer applications: 1) lighting design and visualization software, used primarily to predict illuminance and luminance levels based on lamp and luminaire photometric data input and to provide three-dimensional images of the illuminated spaces, 2) energy compliance software used primarily to assess how lighting systems conform to energy limitations imposed by energy standards, 3) lighting auditing software used primarily to document lighting installations on a luminaire-by-luminaire basis for inventory and energy analysis purposes, 4) website product catalogs and search engines primarily used to locate, compare, and get specifications for products, and 5) websites used primarily for the purchase of lighting products.

Lighting systems are often complex system, the design of which requires an understanding of interactions between distinct components. There are four general classifications of lighting components that make up a lighting system: 1) controller, 2) ballast/driver, 3) lamp, and 4) luminaire. The controller is a device that a) turns lights on and off, and/or b) dims lighting, and/or c) reduces energy consumption. A controller can be manually operated or it can automatically control the lighting operation through software, mechanical means, or sensing mechanisms. The ballast/driver is a device that converts the building electrical characteristics, including voltage, phase, and frequency, into an electrical form required to operate the specific lamp(s) that the ballast/driver is operating. The lamp is the light generating device, and the luminaire is the enclosure that houses the lamps, thereby providing optical control, temperature regulation, and weather protection.

Some lighting components are combination devices, which integrate two or more of these components into a single device, such as self-ballasted compact fluorescent lamps (ballast and lamp) and self-contained light emitting diode (LED) luminaires (driver, lamp, and luminaire). Furthermore, some systems such as line-voltage incandescent systems do not require the ballast/driver component. Most non-incandescent lighting systems are comprised of separate and distinct components in each of the four classifications noted above.

In some cases, each of these four devices in a lighting system is manufactured by different companies. A common example is a fluorescent dimming system, in which the lamp, ballast, dimming controls and luminaires are often manufactured by different companies. Also, there are often multiple levels of controllers (as when lights are controlled by occupancy sensors and daylight sensors). In these cases, significant levels of complexity are added to the design and implementation because, as electrical devices, the ability to interface components with assurance of compatibility is a large concern. The additional complexity is often justified on the basis of additional energy savings or control versatility.

In addition to the lighting system as comprised of the components listed above, environmental factors can affect the performance of the lighting system and the decision of which components are best suited for the application. These environmental factors include temperature, environmental dirt accumulation, luminaire mounting conditions, lamp orientation, aiming direction, function and size of the space being illuminated and surface reflectances.

Lighting systems are generally measured by two metrics: 1) power input (watts, W) and the related value of energy usage (kilowatt-hour, kWh) and 2) light output (lumens, candlepower, etc.). The general term used to define the efficiency of a lighting system is efficacy, defined as lumens per watt (lm/W). Each of the four components and the environmental conditions has an affect on the energy input, light output and the life of the lamp and ballast/driver system (system life).

Persons responsible for lighting designs have at their disposal thousands of product options to choose from. However, the compatibility between the components in a given environment and the end-result of the lighting system performance are often not understood. This is largely due to a fragmented manufacturing, sales, and distribution system. There are few United States manufacturers that make all four components, and the sales representation and distribution channels often follow manufacturer specific channels without allowing for mixing components that might offer better solutions. This problem leads to the design and installation of lighting systems that waste energy, shorten system life, or otherwise underperform compared to an optimized system with matched high-efficiency components. Furthermore, various combinations of components inevitably lead to trade-offs between the three primary decision makers of energy input, light output, and system life, and there is no available objective means to assess and compare these parameters through automatically calculating the resultants of combining a large pool of potential components.

A lighting system is best optimized through an iterative process that explores variations of compatible components with the goal of reaching a desired output that falls within prescribed ranges for the environment in which the system will be operated. In general, this requires a life-cycle cost-benefit analysis that provides the longest system life utilizing the least amount of energy while delivering equal visual capability. Given the market of lighting products, the array of combinations are numerous and generally too exhaustive for an individual to perform manually, as through an iterative analysis. Furthermore, the advancement of new technologies and their interactions with other technologies is constantly changing, making it difficult for lighting engineers to keep up with manufacturer data, technical bulletins and industry trends. These impediments often lead to inefficient and compromised lighting installations.

Thus, there presently exists the need for systems and methods that can match and combine distinct components to form optimized integrated lighting systems in prescribed environments according to user-defined objectives and criteria. Furthermore, there is a need for such systems and methods to promote energy efficiency to reduce the nation's greenhouse gases and dependence on fossil fuels.

### BRIEF DESCRIPTION OF THE DRAWINGS

FIG. 1 is a system-level diagram depicting the logic flow of an embodiment of a system in accordance with the present invention.

FIGS. 2A and 2B are flowcharts describing an embodiment of a method of determining a lighting system in accordance with the present invention.

FIGS. 3A-3I illustrate input and results screens for an embodiment of the system of FIG. 1.

### DETAILED DESCRIPTION OF THE INVENTION

Embodiments of the invention relate generally to lighting and energy design systems and methods and more particularly to systems and methods that utilizes data from lamp, ballast/driver, luminaire, and control manufacturers to design lighting systems.

Embodiments of the present invention comprise systems and methods to calculate the light output of a user-defined lighting system. The systems and methods can include searches of one or more databases of controllers, ballasts/drivers, lamps, luminaires and combination devices for alternative combinations of components to optimize the performance of the lighting system. The results can then be listed in a format that allows users to sort, compare and refine results. For the purposes of this disclosure, the embodiment of the systems and methods of the present invention is referred to as the Lighting System Optimization Software (LSOS) systems and methods.

The LSOS can use a centralized database for storage of information, including product specifications and interaction compatibility. The database is preferably web-enabled, although in other embodiments the database need not be web-enabled. Further, in other embodiments, the database need not be centralized, and can comprise multiple databases. The LSOS database structure includes all existing known component parameters and can be programmed with the flexibility to enable rapid inclusion of new fields as new technologies or design metrics develop. The LSOS is therefore not limited to existing lighting components and design criteria. The LSOS database structure identifies field identification sets for the controls, ballasts and drivers, lamps, luminaires and combination devices based on the characteristics attributable to the component or combination device, including classifications of lower level classifications within the general family of each of the four identified components. For example, the subclass of “occupancy sensors” will have particular attributes as compared to “photocells” within the general classification of “controllers”. Furthermore, the LSOS can allow for matching traits to pair devices for optimization in specific fields, such as when specific lamp/ballast combinations enhance lamp life and warranties.

The LSOS uses manufacturer and/or independent test lab data to calculate the light output of a user-defined lighting system and then searches the database for possible combinations of components that provide a similar light output result based on user-defined calculation methods and output ranges. The LSOS can be used as stand-alone software or be integrated into existing lighting software such as, but not limited to, AGi32 which is developed by Lighting Analysts, Inc. Algorithms within the LSOS can allow for optimization routines to be run based on a set of user-defined conditions that have already been determined through existing conditions, or lighting design concepts that have calculated a light output result. The LSOS can use both standard photopic photometry and Equivalent Visual Efficiency (EVE) algorithms as a basis for determining the light output.

The LSOS allows variations in data input; users can input very specific component identification including manufacturer model numbers, for which the LSOS will calculate values based on product data within the database, or use generic products and values. The LSOS determines component compatibility through field settings within the software that match components by technology, environmental conditions and user preferences.

The LSOS allows users to establish their own criteria to define optimization. User optimization criteria can be established during the information input process through selections of exclusions and/or preferences, as well as through the solution screening process through flexible sorting and comparing options. For example, a user might limit the input by selecting a preference for only one specific manufacturer or lamp type. Similarly, some users might choose the system with the lowest power input from a given set of solutions, while others might prioritize system life or shortest payback.

In one embodiment of the invention, the LSOS operates on a web-enabled database structure for data storage and logical arguments. The user interface software can be implemented as a website search tool, stand alone software, or integrated with other software programs.

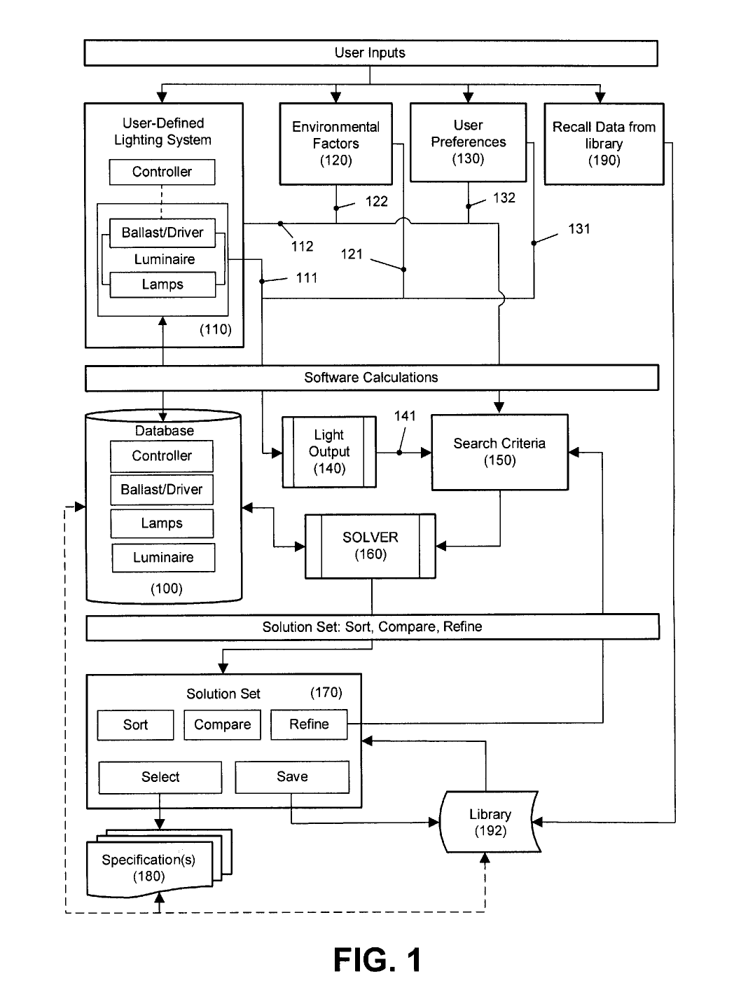

FIG. 1 is a system-level diagram of an embodiment of a system and method in accordance with the present invention. The system will be described in the form of the LSOS. The diagram illustrates three distinct phases of decision-making and calculations. The first phase includes user Inputs. In this case, the user can be an individual or a different software program interfacing with the LSOS. For instance, a lighting retrofit contractor may input the existing conditions of a building, or a lighting software system might input the parameters based on a generic lighting design used to achieve a desired light level. The second phase includes computer calculations. The LSOS takes the information provided from the inputs and first eliminates all devices that are inapplicable. For instance, a 4′ lamp will not fit into a 2′ luminaire. It then forms a solution set of component combinations that meet the user requirements, ranking them into an order by the fields of power consumption, energy usage, payback, system life, or other user-defined parameters that are deemed to be important. The LSOS has the ability to generically categorize solutions based on products of similar characteristics and outputs to simplify the decision-making process. The user can customize the level of detail provided in the solution set. The third phase includes sort, compare, and refine. The list of solutions generated by the LSOS can be, for example, a sortable table that allows the user to compare and refine the solution set so that specific solutions can then be selected. The specifications of each of these solutions are a distinct set of matched products that will provide the desired output. Specifications can then be used as construction document specifications for bidding purposes or for direct purchasing of the lighting components.

Referring again to FIG. 1, in an embodiment, the LSOS utilizes a database 100 containing substructures of lighting controllers, ballasts/drivers, lamps, luminaires, and combination devices. The database 100 can be a web-based, centralized database for storage of information, including product specifications and interaction compatibility; although in other embodiments the database need not be web-enabled and need not be centralized. Each specific type of lighting component is defined by a unique set of fields and relational criteria for matching other components. The database 100 is a dynamic structure allowing for new technologies and operating characteristics to be included as new technologies are introduced. Data input can be manually entered or automatically linked to manufacturer's databases. The database 100 includes data for generic products as well as manufacturer-specific products.

The user inputs information about a lighting system and the environment in which it will be used, the details of which generally fall into three categories: 1) the physical attributes 110 of the lighting system, 2) environmental factors 120, and 3) user preferences 130. The physical attributes 110 of the lighting system, referred to as the User Defined Lighting System (UDLS), include lighting controller(s), ballast(s)/driver(s), lamps(s), luminaires and combination devices. The environmental factors 120 include the physical and environmental conditions surrounding the UDLS. The user preferences 130 allow users to interject their personal preferences as criteria in the LSOS search criteria. The users can also recall data 190 and solutions from previous searches that have been stored in an LSOS library 192.

The UDLS 110 inputs can include specific or generic components. The component values are retrieved from the database 100 query and the LSOS returns the relevant values of the system based on the unique circumstance of the combination of components. The branches of output are twofold: 1) pathway 111 outputs resultant photometric data based on the combination of controller, ballast/driver, lamps, luminaire and combination devices to the light output calculator 140 and 2) pathway 112 enters physical, electrical, and configuration constraints into the search criteria 150. Photometric data and light output includes but is not limited to candlepower distribution, luminance distribution, lumen output, scotopic/photopic (S/P) ratios, and EVE metrics as applicable to the system under consideration.

The environmental factors 120 inputs include descriptors of the physical space in which the lighting system is contained and environmental descriptors that affect lighting system performance and/or search criteria parameters. The branches of output are twofold: 1) pathway 121 informs the light output 140 calculator of the environmental factors that affect lighting calculations, and 2) pathway 122 informs the search criteria 150 of environmental constraints that affect the availability of component choices based on the components' ability to operate under the prescribed environmental conditions.

The user preferences 130 inputs include search criteria such as specific manufacturer or technologies to apply to each or all of the components, systems integration criteria, light output criteria, economic criteria and lighting analysis criteria. The branches of output are twofold: 1) pathway 131 informs the light output 140 calculator of the user preferences that affect lighting calculations, and 2) pathway 132 informs the search criteria 150 of user preferences that affect the availability of component choices or system output limitations resulting from the preferences stated by the user.

The light output 140 calculator calculates the total light output of the lighting system based on user inputs of the UDLS 110, environmental factors 120 and user preferences 130. The calculated light output 140 forms the target light output for which all combinations of possible components must achieve to be listed as a possible solution. Light quantities are defined by summing the product of the light source spectral power distribution (SPD) and the photopic luminous efficiency function throughout the range of visible wavelengths and are known as photopic quantities. However, advances in vision science have demonstrated vision and energy benefits derived from lamps with relatively higher Correlated Color Temperatures (CCT) and there are quantitative methods to calculate these benefits. These formulae for what is termed the EVE method allow for modifications to the photopic measurement of light under some prescribed conditions. For the purpose of this document, when the quantity of light is lumens, the modified lumens are termed “Visually Effective Lumens” (VEL). The light output calculator performs lighting calculations based on both the industry standard photopic light quantities and the EVE calculations, as chosen by the user through the LSOS user input interface. EVE calculations can offer lighting options that are as visually effective as baseline lighting systems at a more economical cost, for example. The calculated light output target values are then sent via pathway 141 into the data set of all search criteria 150.

The search criteria 150 is the collection of all user input data 110, 120, 130 and the light output calculation 140. This combined data set is transferred to the solver 160, the function of which is to: 1) parse the data from the search criteria 150 to form logical arguments and queries which allow the LSOS to search for compatible components from the database 100, 2) calculate light outputs of lighting systems comprised of compatible components and filter to return those combinations that achieve the calculated light output 140 in compliance with user-defined lighting system component requirements 110, environmental factors 120, and user preferences 130, and 3) prepare a list of lighting systems comprised of compatible components for inclusion in the solution set 170. The solver 160 thereby utilizes the light output of a user defined lighting system, and through the use of logical arguments established by the user, analyzes lighting systems to provide a set of lighting system optimized to achieve the equivalent light output.

The solution set 170 user interface allows the user to sort the possible lighting systems by categories consistent with the lighting criteria established in the user preference 130, compare user-selected lighting solutions in more detail by selecting specific solutions for further analysis, and refine the solution set by re-defining parameters set in the original user inputs 110, 120, 130. Refinement of the data through the solution set 170 begins a new calculation with revised input in the search criteria 150 and solver 160 to define another solution set. The LSOS retains data from each search as a unique record.

The solution set 170 includes capabilities for numerous sort, compare, and refine iterations and allows users to save any number of searches and results in the LSOS library 192. Users can access the library 192 at the beginning of the LSOS through the recall data 190 function or at any time while reviewing the solution set data 170. The LSOS library structure allows users to save data in a user-defined file structure that links to database 100. Recalled data from the library 192 is first displayed in the solution set 170 formats, from which users can review the file, make changes as desired, and save the new search criteria as a different file for retrieval.

The LSOS generates detailed specifications 180 for the individual components and the overall performance of the integrated systems selected through the solution set 170. The specification summarizes 1) the user-defined lighting system, environmental factors, and user preferences inputs to the LSOS 110, 120, 130, 2) the calculated light output 140 and its quantification methodology, and 3) the pertinent search criteria 150 that sets delimiters used to parse data within the solver 160. The detailed component specifications include the specifications data housed in the database 100, the attributes of which are dependent on the specific type of component or combination device selected. The overall performance of the integrated system is listed in the specification in accordance with the search criteria and sort/compare/refine paths chosen by the user through the search criteria 150 and solution set 170 tabulations.

### Logical Arguments, Calculations, and Algorithms

### General Logical Argument

The LSOS uses an object-oriented query that operates under the following general argument and definitions: For any given lighting system, LS(0) consisting of any combination of the assembled components (1) luminaire, (2) lamp(s), (3) ballast(s) or driver(s), and (4) controller(s), inclusive of any form of combination device, operating in a specific environment and generating light output LO(0), there exists multiple other Lighting Systems {LS(1), LS(2), LS(3), LS(4), . . . LS(n)} with equal or nearly equal light outputs {LO(1), LO(2), LO(3), LO(4), . . . LO(n)} that will have different operating characteristics that may be more optimal than the given system LS(0) as a result of being assembled with different components. For the purpose of this document, the LS(0) will be termed the baseline lighting system.

The term ‘operating characteristics’ describes the overall performance of the lighting system, particularly as related to energy and economics. In this case, since the light output is the independent variable held constant within a user-defined range, the ‘operating characteristics’ that are considered for system optimization include the following: (a) lighting system efficacy (lumens per watt), (b) lighting system input power (watts), (c) lighting system energy usage (kWh), (d) lighting system rated lamp life, (e) payback (relative to LS(0)), and (f) life-cycle cost-benefit benefit (relative to LS(0)).

### Lighting Calculations

The LSOS can perform lighting calculations utilizing the visual response to the spectral composition of light, which is not solely dependent on the use of the photopic luminous efficiency function upon which light is defined. While the current mathematical model employed in the LSOS uses the S/P value and the exponential formula described below, other potential formulae may apply to differing applications, including possible visual responses characterized by metrics other than S/P value and/or formulae using the S/P value but with differing algebraic expressions, and/or formulae using the same algebraic expression but with a differing exponent. In general, light output for the LSOS is referred to as the visually effective lumens (VEL) generated from the fully assembled lighting systems in a given environment using standard lighting engineering methods. When luminous intensity, luminance, or luminous exitance are used as a basis for calculations, the same VEL factors apply, and the resultant illuminance levels are referred to as visually effective illuminance (VEE). For the purpose of this example, we will use VEL (VEE is VEL per unit area incident on a surface) and the visual task under consideration is to attain equal visual acuity. VEL is currently defined as VEL=P(S/P)^{x}, where P is the photopic lumens as defined by lamp manufacturers in their catalogs and specifications or independent test results, S/P is the scotopic/photopic ratio provided by lamp manufacturers or independent test results, and the exponent “x” is 0.80 for the visual task of maintaining visual acuity. Lighting calculations are relegated to three generic types: (a) calculation that includes properties of the luminaire and the room, (b) simplified lamp and ballast/driver replacement calculations, and (c) equivalent candlepower distributions comparisons.

In the case where luminaire changes are proposed within a space, the type (a) calculations include properties of the luminaire and the room. The basis of the calculation is the IESNA lumen method calculation, and the light output used to form equivalence is visually effective illuminance:

$$V E E = \frac{V E {L}_{perlamp} \times {N}_{lamps} \times B F \times C U \times L L F}{Area} \qquad Eq . 1$$

Where:
VEE=Visually Effective Illuminance
VEL=Visually Effective Lumen output per Lamp
N=number of lamps per luminaire
BF=Ballast Factor (or Driver Factor equivalent)
CU=Coefficient of Utilization of the Luminaire in a given room
LLF=Light Loss Factor
   where the lumens per lamp is defined in the previous paragraph.

The ballast factor (BF) is a value specific to the ballast/driver and lamp combination that defines the percentage of light output (per lamp) that will be delivered by the specific lamp, ballast/driver, and number of lamps being driven by the actual ballast/driver as compared to a reference ballast driver (whose BF=1 and is used to define the rated lamp lumen output that is published by the lamp manufacturers). These values are a cataloged property of the ballast and are contained within the LSOS database.

The coefficient of utilization (CU) is defined by the room geometry, reflectances, ceiling height and task height. The CU represents the efficiency of the luminaire in a given room geometry with known reflectance's. When the LSOS is considering lighting retrofit kit options or alternative luminaire options, this number must be used in the calculation.

The total Light Loss Factor (LLF) is a cumulative factor taking into account recognized IESNA factors inclusive of Lamp Lumen Depreciation (LLD), a function of lamp used, Luminaire Dirt Depreciation (LDD) factor, a function of environment and luminaire design, room surface dirt depreciation, a function of room environment, and temperature factor(s), a function of environment, lamp, ballast/driver and/or luminaire. The factors affecting the LLF are variable depending on the application. Some designs are simple and require only the LLD, whereas others might require adjustments inclusive of all the factors noted above. As future technologies such as LEDs expand into the marketplace, additional factors can be added to the LSOS.

For type (b) calculations the LSOS can define the optimized system as a simplified replacement of the lamp and ballast/driver only, with no presumption of a change in the luminaire or luminaire optics. Replacement of the lamp and ballast/driver only, where the optics of the luminaire do not change or change only slightly within known limits, can provide favorable economics in lighting retrofit applications. In such embodiments, the luminaire or luminaire optics may actually be replaced; however, the type (b) calculation assumes that the replacement does not substantively differ from the performance of the baseline luminaire or luminaire optics. Thus, in some embodiments, type (b) calculations are the primary calculations for the program, the basis of which is the total visually effective lumen (VEL) output of the luminaire, since the calculation basis need not require further computation of lighting distribution from the luminaire or calculation of illuminance. The formula is therefore simplified to:

VELₜₒₜₐₗ=VELₚₑᵣₗₐₘₚ×Nₗₐₘₚₛ×BF×LLF×LEF Eq. 2:

Where (in addition to terms defined in Eq. 1):

LEF=Luminaire Efficiency Factor

In this case, the Luminaire Efficiency Factor (LEF) for the baseline lighting system is 1.0, and alternative lamp and ballast/driver combinations may increase or decrease the efficiency of the light output depending on the relationship of the possible configuration change to the luminaire. For instance, changing a luminaire from a 4-Lamp configuration to a 3-Lamp configuration increases the efficiency of the luminaire (the exact figure depends on the luminaire type). Note that CU is omitted from this calculation since the lighting optics is not changed.

For type (c) calculations the LSOS establishes the candlepower distribution values of a baseline lighting system from the luminaire database, compares this to other luminaires that meet the search criteria, and outputs a list of different lighting systems that can provide the same or nearly the same lighting distribution and light output. In these cases, the calculation is one of reducing tabular values of candlepower distributions, luminance data and zonal lumens within the database to candelas (cd), cd/m2, and lumens respectively, per 1000 lumens for luminaires with undedicated light sources, and the EVE calculations for the baseline case. For example, the LSOS would reduce the photometric report from a lensed 2′×4′ fluorescent luminaire with defined photometric distribution to light output per 1000 lumens (inclusive of VEL calculation) based on the lamp ratings used in the photometric report. This calculation will be performed and resident within the database for a luminaire, and be used to consider options for optimization from light sources that differ from the fluorescent luminaire. For instance, a 2′×4′ fluorescent luminaire could be replaced by an LED 2′×4′ luminaire on this basis, assuming a one-for-one replacement of luminaires, only if the photometric candlepower distributions of the potential LED luminaire have approximately the same light output and distribution.

### Energy Calculations

Total power: Total power consumed by a given lighting system is generally determined by the combination of the lamp and ballast/driver combination (“x” number of lamps being driven by one ballast/driver) or the sum of different lamp and ballast/driver combinations within a lighting system, and includes any effect of the controller or luminaire. The unit is watts.

Lighting system efficacy: Efficacy is defined as the light output divided by the power input and is thereby a measure of the overall efficiency of the lighting system in delivering light. The units are Lumens Per Watt (LPW). The LSOS calculates both standard efficacy (photopic LPW) and EVE LPW, consistent with formulas defined above.

Lighting Power Density (LPD): The LPD is a standard used in energy codes in prescribing maximum allowances for lighting energy use in buildings. The units are watts per square foot or watts for square meter. The LPDs are calculated in cases where room information is provided to the program.

Annual energy usage: Calculation of annual energy usage determines the overall energy usage for the lighting system using the formula:

Energy=Power×Time.

In these calculations, a user must input assumptions on annual hours of operation and time-load variations (if applicable). The unit is kilo-watt hours (kWh). There are two variations of this formula: (1) constant power input and (2) variable power input.

In the case where the power input is constant, i.e. there is no dimming or partial-switching assumptions built into the equation, the annual energy usage is the total power multiplied by the annual hours of operation. For automatic on/off controllers, the user can input presumed annual hours of operation and percentages of time that the controller is presumed to turn the lights off (as in the case of on/off occupancy sensors).

In the case where the lighting system uses variable power components (i.e. dimming ballasts and controllers), the user must define the presumed hours for which the load is reduced and the resultant load of the system when the system is dimmed or controlled at the variable level. For equipment whose power input has a linear relationship to lighting levels, the user can input the percentage that the lighting is dimmed as a proxy for power reduction. The program will have the capability to include power reductions for specific equipment on the basis of lighting reduction only when the manufacturer provides that information for inclusion into the program; however, this information is exceedingly difficult to obtain and therefore cannot be assured for all light-level reduction components. The program will include calendar formats for User input to make seasonal adjustments of hours, such as required for outdoor lighting and photocell controlled lighting used in conjunction with day lighting systems.

### Economic Calculations

In some embodiments, the LSOS performs economic calculations using an abbreviated version of the Life-Cycle Cost-Benefit Analysis (LCCBA) calculations prescribed by the Illuminating Engineering Society (IES). Specifically, LSOS uses the aspects of the value of money and system life assumptions to put costs on a present value (PV) or annualized cost (AC) for the life of the system, incorporating annual energy costs and replacement costs for the lamps for the life of the system. The user therefore must prescribe the system life, assumptions for the cost of money, and the energy cost (both present and inflation-adjusted). All economics use the baseline lighting system as the basis for comparison.

In some embodiments, the LSOS uses assumptions for material and labor costs. The costs of materials are based on averaged costs from manufacturers for specific products that meet a generic description. The assumptions of material cost within the LSOS are tied to manufacturer data. The user has flexibility as to how they input the assumptions for labor costs. Labor rates can be defined using per-hour labor rates with the LSOS assigning labor hours per task, cost per square foot, or flat costs per task. In new construction projects, there are generally no assigned labor rates where the luminaire distributions and light output are similar (when there is no difference in installation between the selected lighting system and the baseline lighting system). In lighting retrofit scenarios, the baseline lighting system cost is presumed to be zero. Lamp change-out labor rates can be assigned using regional maintenance labor rates according to regional industry norms; with user defined options of spot- or group re-lamping economic factors applied using the LCCBA formulas.

Payback: LSOS calculates the time that it takes to recoup any additional investment required to change from the baseline lighting system to the alternate lighting system. In the case of new construction, payback may be defined in negative terms, i.e. the alternate lighting system may be less expensive than the baseline lighting system input by the user. The unit is years.

Long-term benefit: LSOS calculates the overall present value cost savings that the alternate lighting system will bring to the user when compared to the baseline lighting system. The long-term benefit describes the total amount of money to be saved during the life of the system.

### Hierarchy and Algorithms

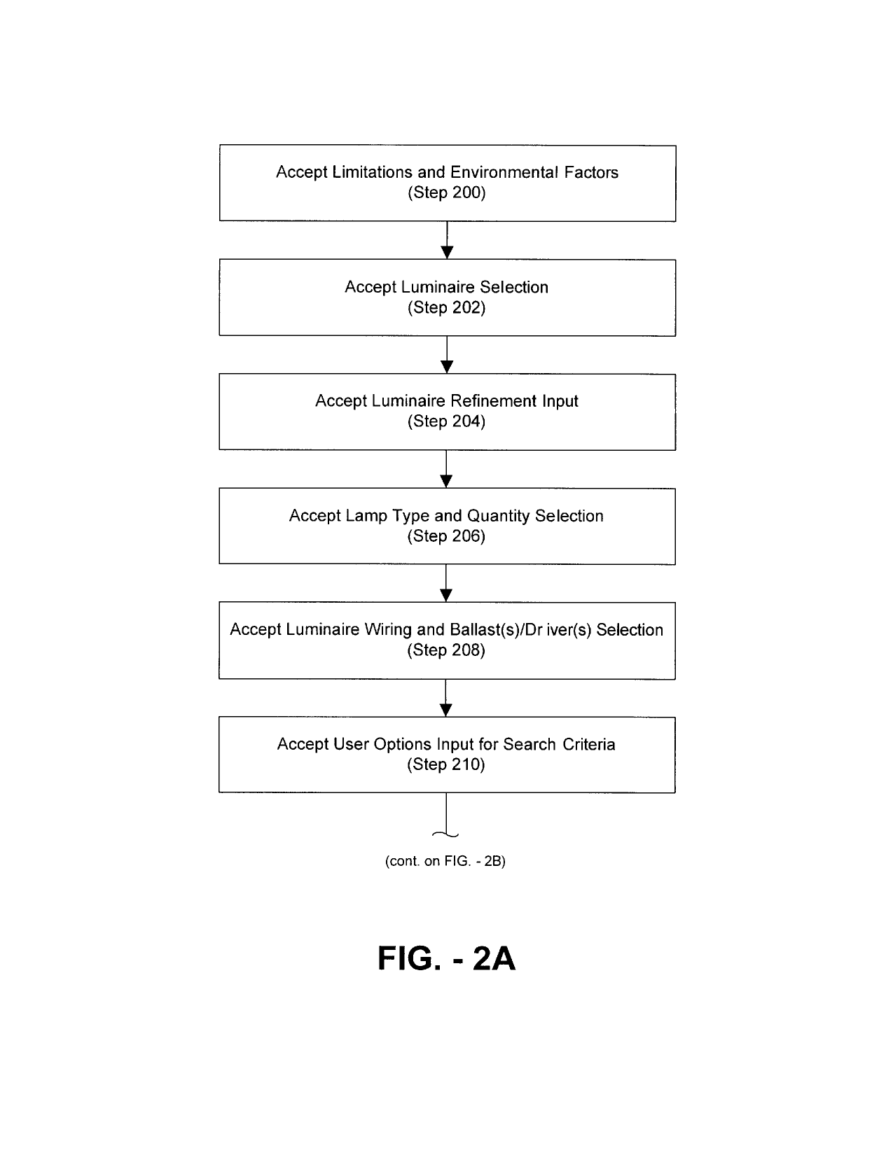

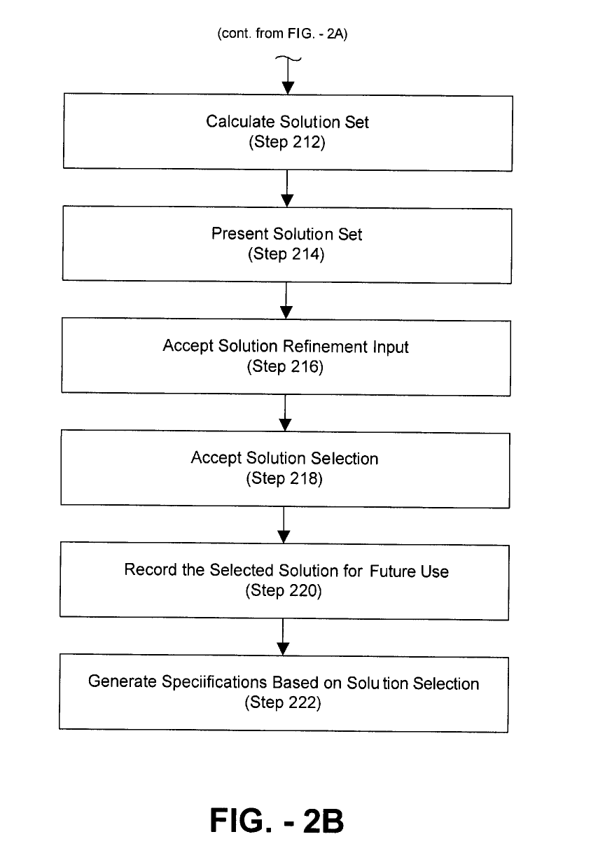

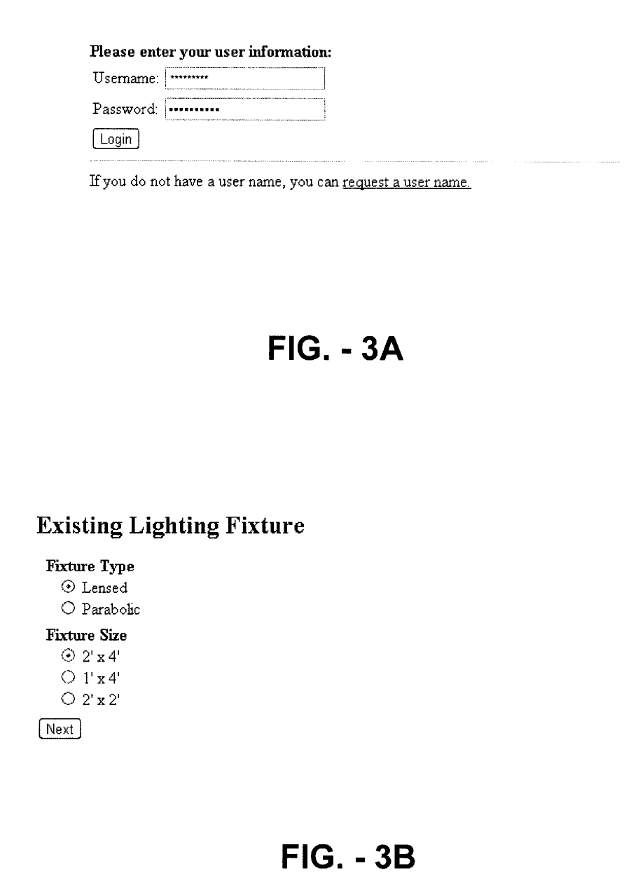

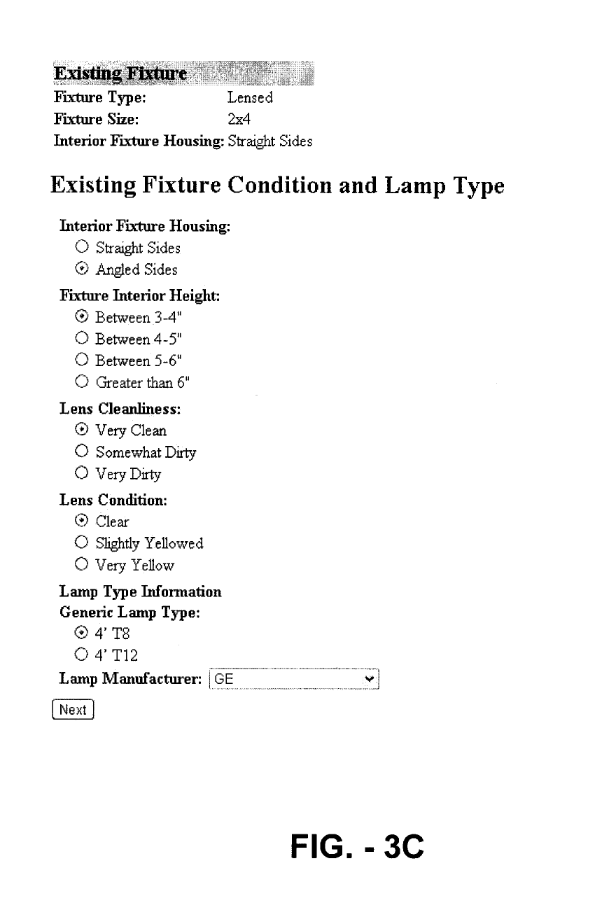

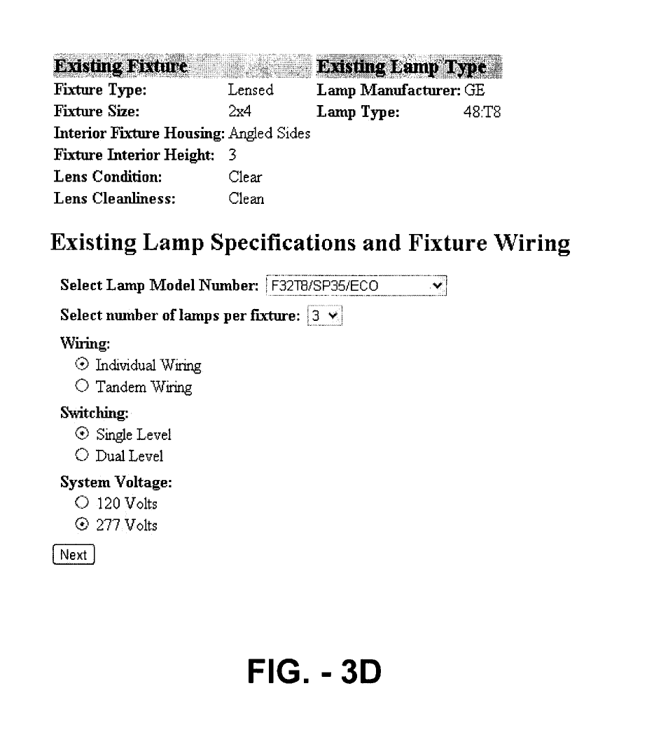

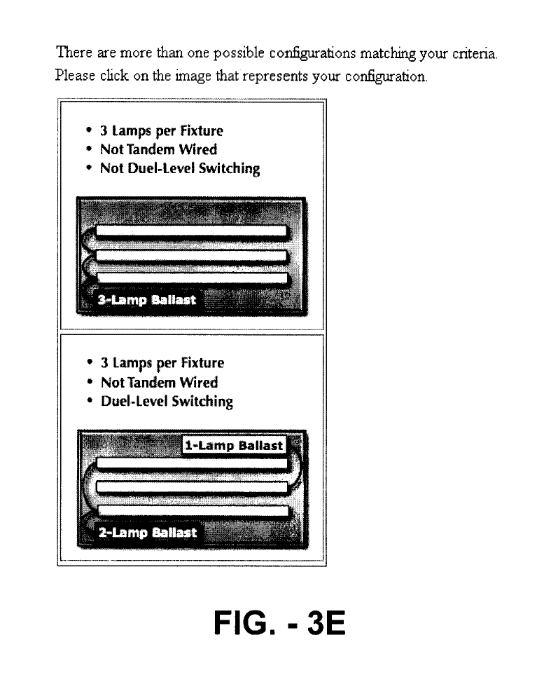

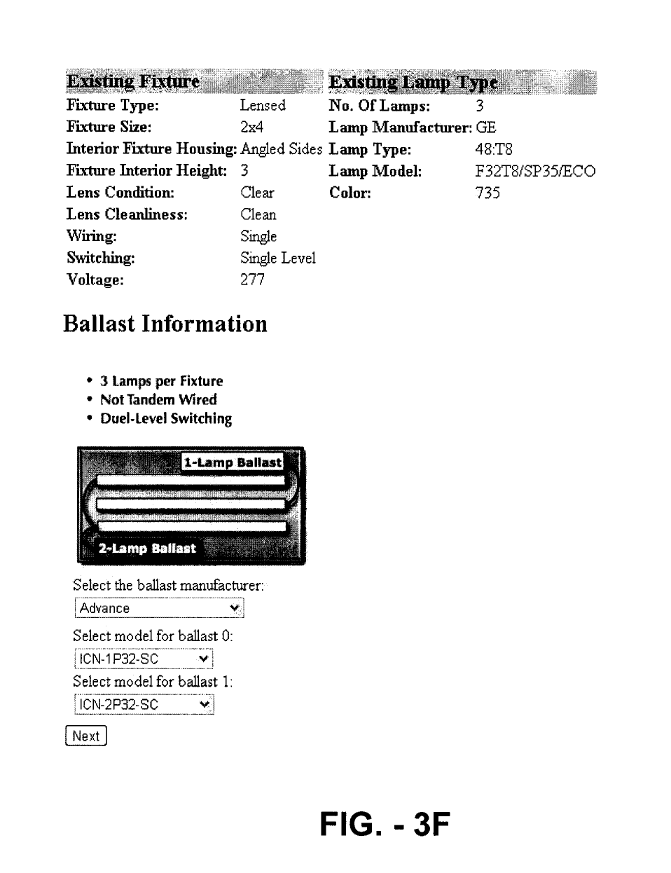

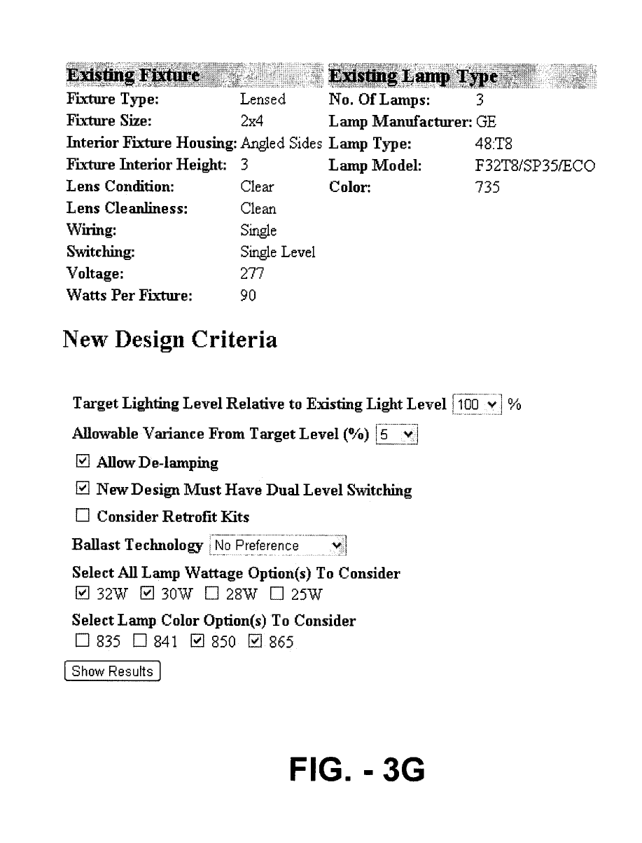

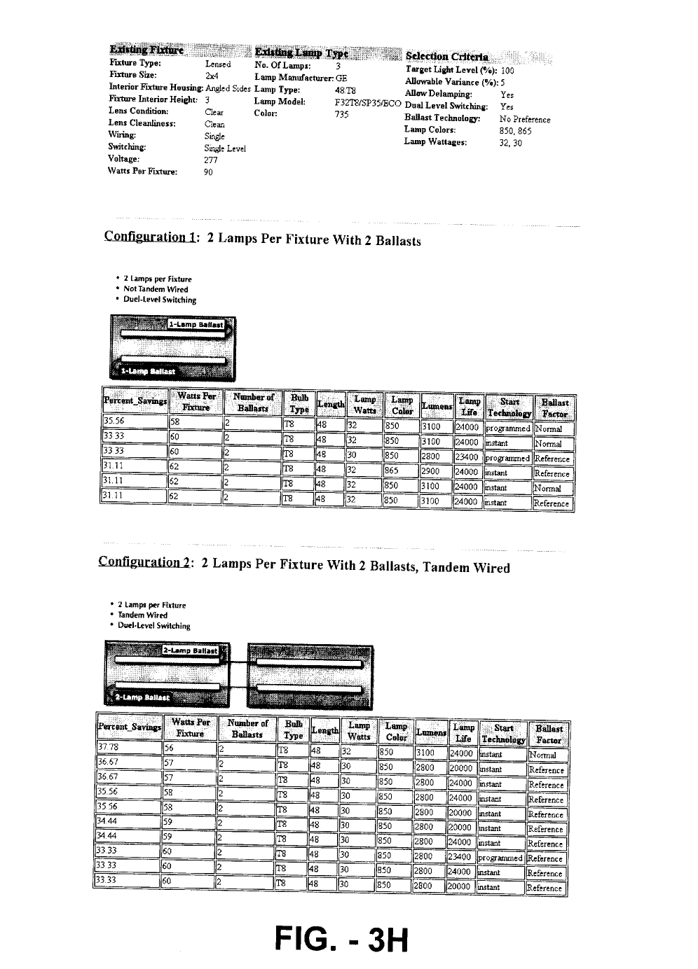

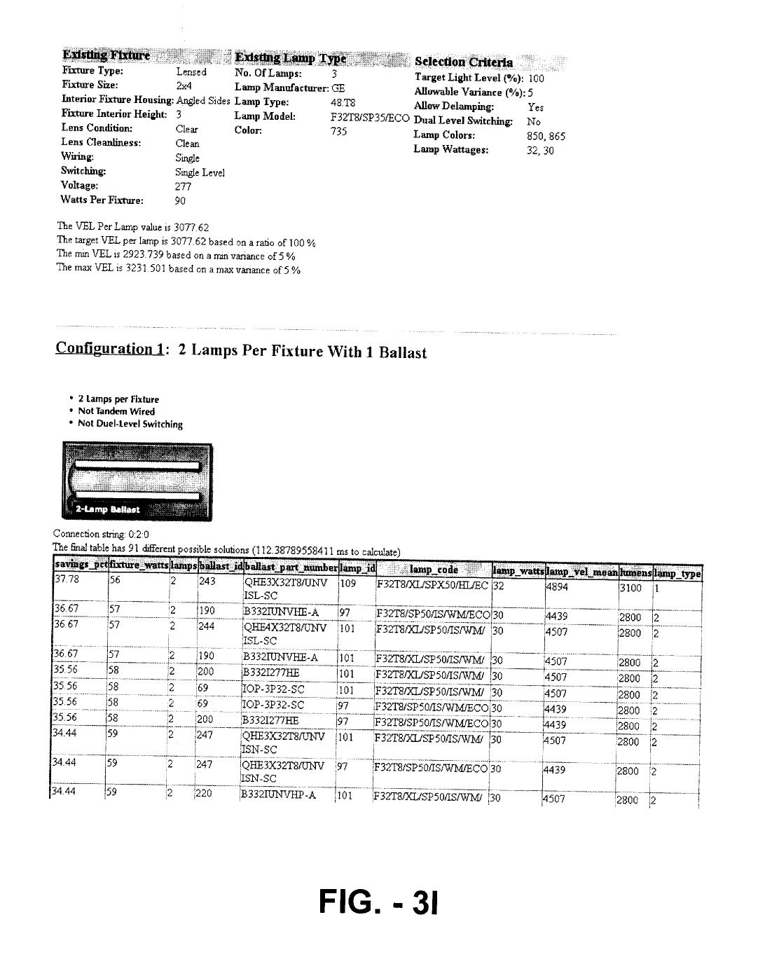

FIGS. 2A and 2B are flow charts of an embodiment of a method in accordance with the present invention. The method is an analysis process by which the light output of a given baseline lighting system is first determined through an analysis of its various components and then other lighting systems are determined that can be used in the same application to provide the same or nearly the same light output with different components whose combination results in lower operating costs. The method is performed, in an embodiment, by the LSOS. Examples of selection screens presented to the user when the LSOS executes the method are shown in FIGS. 3A-3I. The hierarchy of the LSOS uses existing conditions (an existing lighting system, as when using the program for lighting retrofits) or a pre-determined design (as with new construction). In either case, the general assumption is that there exists a baseline lighting system LS(0) that consists of a luminaire with specific lamps and ballasts/drivers that are operated by specific controller(s), noting however that in some cases a lighting system could be completely integrated as a single unit that has integral lamp and/or ballast/driver components, as in the case of some LED luminaires. The hierarchy therefore starts with a description of the baseline luminaire. The luminaire defines the physical constraints that determine the lamp choices. The lamp choices define the possibilities for the ballast/driver choices and the ballast/driver choices impact the possible controller choices. The hierarchy and algorithms are best described in the step-by-step method below:

The method can include accepting limitations and environmental factors (Step 200) input by a user. The user can log in to the LSOS to associate the inputs with the user (FIG. 3A). The LSOS can be used to perform room-by-room analyses or a simpler lighting system comparison for one or several user defined scenarios. The LSOS defines the type of analyses to be performed and sets up the conditions for the analyses. For example, for a room-by-room analysis, the user sets up a job profile, which can generate room entry screens that allows users to define the room sizes and the number and types of luminaires as the program progresses. Each room entry sets the environmental factors that may have an effect on the light output including the room dimensions and presumed temperatures of the spaces. The room-by-room analysis can correspond, for example, to both ASHRAE 90.1, and to California Title 24 analysis methods. The user can choose to perform the program operation using multiple different energy standards and/or utility incentive programs as a basis of calculation and comparison.

The method can then accept luminaire selection (Step 202). The LSOS can present a selection of generic luminaire types for the user to choose from. Each type can include a list of possible sizes and/or configurations for the user to select. For example, as shown in FIG. 3B, recessed lensed fluorescent luminaires can be selected from three sizes (2′×4′, 2′×2′, 1′×4′) and recessed parabolic fluorescent luminaires can likewise be selected from three sizes (2′×4′, 2′×2′, 1′×4′). The choice of luminaire type and size defines the choices of lamps that can be used due to the physical limitations imposed by the luminaire. In addition, each luminaire type has specific construction and optical control variations that require refining, and that adjust the light output calculations and/or present limitations that affect lamp or ballast/driver choices. The LSOS has no limitations as to the number of types of luminaires that can be included in the database. In addition, some analyses may be required for directional lamps (PAR, R, MR lamps, etc.) whose data for comparison is the direct candlepower distribution curve for the lamp and the luminaire is more or less irrelevant. In these cases, the LSOS can skip the luminaire step and instead go directly to the lamp selection data to establish the basis for the comparisons and calculations.

The method includes accepting luminaire refinement input (Step 204). Each luminaire type and size combination presents several options that may be further defined in order to assess the light output and further define lamping and ballast/driver options. Referring to FIG. 3C, the LSOS presents the unique attributes for the chosen luminaire type/size combination to the user. The user selects inputs to the program, and can choose, for example, the options for the generic lamp type that is used in the luminaire. For example, recessed lensed fluorescent luminaires will question the user about the condition of the lens, whereas users will be asked to define the number and configuration of parabolic cells for recessed parabolic fluorescent luminaires; 2′×2′ luminaires have different lamp options than 2′×4′ luminaires.

The method then accepts lamp type and quantity selection (Step 206). Referring to FIG. 3D, the LSOS prompts the user to select the specific lamp being used (e.g., by manufacturer and model number, or a generic description) and the number of lamps in the luminaire. The selected lamps, number of lamps, and luminaires set parameters for defining possible choices of ballast(s)/driver(s) and controller(s). For example, a 2′×4′ recessed fluorescent luminaire will use 4′ fluorescent lamps. The quantity of lamps and the manufacturer and model number of the lamps are limited by this selection, factors that can affect the ballast choice, light output, spectral composition, and lamp life.

The method then accepts luminaire wiring and ballast(s)/driver(s) selections (Step 208). Referring to FIGS. 3D and 3E, the LSOS allows the user to select wiring and switching modes, and building system voltage that, along with the luminaire and lamp selections in Steps 202 and 204, set criteria for the ballast/drivers compatible with the aforementioned components. The user is then given the opportunity to select the specific ballast/drivers being used in the lighting system (FIG. 3F). For example, a recessed fluorescent 2′×4′ system with 3 lamps per luminaire that is not dual-level switched and without tandem wiring may have two possible wiring configurations, which are 1) (1) 3-lamp ballast or 2) (1) 1-lamp ballast and (1) 2-lamp ballast, and the user defines which of these two options are to be used to establish the baseline condition (FIG. 3E), and the user defines which configuration represents the baseline case. Once the number of ballasts per luminaire is defined, the specific ballast(s) are selected for the baseline condition, one option of which is generic ballast(s). The wiring of the luminaire and the manufacturer and model numbers of the ballasts define the power input of the lighting system. In addition, this information provides data for the LSOS regarding the ballast start characteristics (parallel or instant start), wiring to the lamp sockets, and wiring from the controller to the luminaires, all of which can have economic ramifications when considering alternative lighting systems.

Steps 202, 204, 206, and 208 define the components used in the lighting system and calculate the system power input, light output, and lamp life. The method next accepts user options input for search criteria (Step 210) that will be used to calculate the desired lighting system characteristics required for the solution. This step can include the user options for including control components. Referring to FIG. 3G, the LSOS can allow the user to define conditional statements that will affect the solution set presented by the LSOS. The first condition can affect the light output calculation by allowing the user to 1) match the light output exactly, or 2) reduce the light output by “x” amount, or 3) increase the light output by “x” amount. These selections set the basis for the light output calculation of the baseline lighting system. Several other options for the User are presented based on the luminaire type and size, lamp, ballast/driver selections, and wiring options that have been chosen in previous steps. For example, the LSOS can ask the user to define options that the user wants to include that will affect the choices of lamps and/or ballast/drivers, and that could affect the light output, the power input, or both. The user can also be given toggle fields that prompt the LSOS to suggest lighting retrofit kits, alternative luminaires, or controllers that might provide additional energy savings (in many cases, these options can be undesirable due to economic ramifications). For example, for the recessed fluorescent luminaires described above, the user might define parameters that require the solution set to only consider systems with 2-level switching. This could be defined because of a requirement to qualify for tax incentives, for example. The user might then define the hours per start for the fluorescent lighting system and the utility rate, both of which can affect payback. The user might then define which lamp wattage and colors they want to consider in the solution set. The user might then define whether the solution set should consider retrofit kits, and whether occupancy sensors or daylight dimming systems should be considered, which can affect the ballast solutions that will be presented in the solution set.

The previous steps have thus comprehensively analyzed the baseline lighting system and have set the desired criteria for selecting an optimized set of solutions, using compatible components housed in the database. The analysis method in the LSOS calculates the photopic and EVE light outputs for the baseline lighting system pulls optional components from the luminaire, lamp, ballast/driver, and controller databases and combines them in ways that will meet the design criteria entered by the user. The program assesses the light output of all the possible alternative solutions, rejects those that do not meet the baseline light output calculation, and returns only those lighting systems built of the new components that fall within the range of light outputs that match the baseline lighting system criteria (Step 212).

After the solution set has been calculated, it is presented to the user (Step 214). The initial presentation of the solution set by the LSOS will often be extensive due to the large number of combinations of products available that will match the baseline lighting system criteria. The first presentation therefore will provide rough guidance. For example, lamp and ballast/driver types will be presented as generic choices and not by specific manufacturer and model numbers. This generic solution set provides the user with many high-level options from which to choose. As can be seen, in FIG. 3H, the configurations 1 and 2 offer alternative configurations that utilize two lamps, rather than the existing three lamp fixture type, but differ in their ballast wiring. The LSOS will allow the user to check “compare” buttons for those options that the user wants to explore more deeply, typically the ones that show the best economic or energy-saving potential. For every generic lamp and ballast/driver combination, there may be more than a dozen combinations of specific lamp and ballast/driver model numbers, and the LSOS therefore reduces confusion caused by too many options by displaying the initial solutions set with generic descriptions. FIG. 3H is an example of a partial listing of the solution set including generic descriptions presented by LSOS. FIG. 3H shows possible configurations 1 and 2 out of the full listing of configurations 1-5. FIG. 3I is a partial listing of the configuration 1 solution set including non-generic descriptions.

The method then accepts solution refinement input (Step 216). The LSOS allows the user to compare solutions from the solution set. After checking the “Compare” buttons for the chosen solutions desired, the user will be presented with a more concise listing of possible lighting systems composed of various component combinations. In an embodiment, the initial ranking is by energy savings relative to the baseline case in descending order, with the table being presented in a field-heading format where the user can click any heading for changing the sort order. The refined set can be resolved further through repetitive steps and the user can keep the generic solution or expand the solution set to show all combinations with specific model numbers once they have determined their preferred list of generic options.

The method then accepts the solution set (Step 218). The LSOS allows the user to select the solution at any time during the previous step. Once a selection is made, the LSOS displays the specifications of the proposed solution, with generic specifications or exact model numbers. The user then selects the preferred solution, the LSOS logs this event as a decision with the paired baseline lighting system and selected lighting system defined as a uniquely coupled pair, allowing the user to define the baseline/solution as a Fixture Type with a label of the user's choosing. The specific coupling of baseline and solution lighting systems can be replicated in any future project or in other rooms within the user's project.

The method then includes recording the selected solution for future use as a fixture type (Step 220). The LSOS can automatically store the fixture type in the user's fixture library once the fixture type is defined. The fixture type information can be recalled at any time for replication in other rooms or for use in other projects. If the user is making this selection within the framework of a room-by-room analysis, the user can be presented with options to choose solutions stored with the fixture library for other rooms. For example, if the room being worked on is a typical private office, and there are one hundred of these offices on the project, the user can either count the number of repetitive office types or input actual office numbers from the floor plan such that each room is unique, but with the same fixture type and room geometry. The former is allowable when the rooms are exactly the same size and the latter can be helpful for repetitive rooms insofar as the solution goes, but where the user can later make revisions to the rooms based on differences in room size.

In the room-by-room analysis, rooms can be stored in a room library; both rooms and fixtures are related to the project library. At any point, the user can recall a room and make changes, at which time the program will ask whether to apply the change to the specific fixture type as a universal change (to all incidents of its use) or to only a unique application that is similar. For example, if the user has a fixture type that is used in all instances of private offices except in one room, where they need to change the light output assumption, the user can re-calculate and select a new solution, at which point they assign a new fixture type for that unique application. These steps avoid having to re-input all the previous steps in assigning properties to the baseline lighting system.

The method then includes generating specifications based on the solution selection (Step 222). For each fixture type, there is a specification that describes the components used for both the baseline and selected lighting system. The specification lists the performance specifications of the selection as well as the specific criteria for each of the components, including manufacturer and model numbers that meet the specifications of the components. This specification can be generic, as is used for general bids, or specific to single manufacturers. The user has an option within the framework of the program to list components by manufacturer and model number showing the specific quantities of each of these components.

In other embodiments of methods in accordance with the present invention, additional steps can be performed before or after solution selection. In one LSOS embodiment, the LSOS can include built-in algorithms to search distributors in the region of the project to provide actual costs on a bid basis to the user. The LSOS can also support online purchasing. The LSOS can use filters for matching components within manufacturers to optimize purchasing power. For example, a lamp and ballast/driver combination from Manufacturer A might be less on one fixture type but Manufacturer B might be less for a different fixture type. Since costs are predicated on the manufacturer volume for the entire job, the program can evaluate system prices as packages to ensure that the overall price is as low as possible. The LSOS can also include algorithms with weighting factors for warranty and callbacks.

In one LSOS embodiment, the data collected in the LSOS optimizes lighting systems for each fixture type and suggests alternate controllers based on the application. On a project basis, the program therefore optimizes the entire lighting system with the objective of meeting or exceeding established energy standards. The standards are generally set by each State, and can therefore be easily determined by zip code, as an example. In addition, regional state, and utility incentive programs generally base their values on either specific product replacement programs (as documented in the specifications), exceeding the LPD requirements of the energy standard (as determined in the room-by-room or similar analysis), and/or through incorporation of specific controller types (room-by-room or similar analysis).

In another LSOS embodiment, the LSOS can produce energy standard compliance forms for the various state energy standards and will record the data for retrieval at any time. The three major standards include California's Title 24, ASHRAE/IESNA 90.1 (inclusive of various versions as adopted by the states), and the ICEEE. Compliance forms and documentation can be shared documents according to the author's choice, which allows the sharing of the documentation with utilities, states, building department agencies, the internal revenue service (IRS), the federal government, etc. For certain programs, this sharing will be required to ensure that there is no double-dipping by the project.

In another LSOS embodiment, the LSOS uses the specifications and energy standard compliance information with the database of state, regional, and national incentive and tax benefit programs to determine if the project qualifies for incentives, and to assess options that maximize the benefit to the owner if there are conflicting or alternative programs that cannot be used in conjunction with each other. Specifically, the program will determine the maximum tax advantage available through current energy conservation tax incentives at the federal and state level.

In some embodiments, the user can select from a variety of outputs that summarize the project data, including: a) product specifications by project, room, or fixture type, b) fixture schedule/summary, c) room-by-room summary, d) project energy summary, e) energy standard compliance forms, f) federal tax Incentive documentation, and g) state and regional incentive compliance forms.

Throughout the various contexts described in this disclosure, the embodiments of the invention further encompass computer apparatus, computing systems and machine-readable media configured to carry out the foregoing systems and methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro-drives, magneto-optical disks, holographic storage, ROMs, RAMs, PRAMS, EPROMs, EEPROMs, DRAMs, VRAMs, flash memory devices, magnetic or optical cards, nano-systems (including molecular memory ICs); paper or paper-based media, and any type of media or device suitable for storing instructions and/or information. The computer program product can be transmitted in whole or in parts and over one or more public and/or private networks wherein the transmission includes instructions which can be used by one or more processors to perform any of the features presented herein. In various embodiments, the transmission may include a plurality of separate transmissions.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for determining a series of alternative lighting systems having reduced energy usage over a baseline lighting system, comprising:
receiving an identification of a plurality of baseline components of the baseline lighting system;
calculating estimates of system performance characteristics of the baseline lighting system based on specified performance characteristics of the identified baseline components; and
determining the series of alternative lighting systems based on the estimates of performance characteristics of the baseline lighting system, each alternative lighting system including a plurality of mutually compatible components obtained from a database specifying performance characteristics for a plurality of components including the mutually compatible components; and
wherein the series of alternative lighting systems are presentable hierarchically based on at least one of energy usage, economic criteria, and rated life.

2. The method of claim 1, further comprising:
permitting selection of a lighting system from the series of alternative lighting systems.

3. A method for enabling selection of a lighting system, comprising:
receiving an identification of a plurality of baseline components of a baseline lighting system;
calculating estimates of performance characteristics of the baseline lighting system based on specified performance characteristics of the identified baseline components;
determining a series of alternative lighting systems based on the estimates of performance characteristics of the baseline lighting system, each alternative lighting system including a plurality of mutually compatible components obtained from a database specifying performance characteristics for a plurality of components including the mutually compatible components; and
enabling the selection of the lighting system from the series of alternative lighting systems.

4. The method of claim 3, wherein the baseline lighting system includes one or more of a controller, a ballast/driver, a lamp, a luminaire, and a combination device.

5. The method of claim 3, wherein the baseline lighting system is one of an existing lighting system targeted for replacement, a new lighting system design, or a hybrid lighting system including at least one component of an existing system targeted for replacement and at least one new lighting fixture design.

6. The method of claim 3, wherein enabling the selection further comprises:
presenting the series of alternative lighting systems;
wherein presenting includes one or both of displaying the series of alternative lighting systems on a display screen and printing the series of alternative lighting systems to a visual medium.

7. The method of claim 6, wherein the series of alternative lighting systems are presented hierarchically based on at least one of energy usage, economic criteria, and rated life.

8. The method of claim 3, further comprising receiving a wiring scheme and/or switching scheme of the baseline components of the baseline lighting system.

9. The method of claim 8, further comprising receiving input describing a physical condition of the baseline components of the baseline lighting system.

10. The method of claim 9, wherein the physical condition of the baseline components includes one or more of luminaire housing geometry, luminaire interior height, lens cleanliness, lens condition, configuration of louvers.

11. The method of claim 3, wherein the series of alternative light systems is determined based on a calculation that produces light output generally equivalent to the baseline lighting system.

12. The method of claim 11, wherein the calculation is performed with photopic light metrics and equivalent visual efficiency (EVE) lighting metrics, wherein the EVE lighting metrics include performance characteristics of a light source spectral power distribution and an effect on vision of the light source spectral power distribution.

13. The method of claim 12, wherein the EVE lighting metrics are defined by the equation
EVE₍ₘ₎=P₍ₘ₎×(S/P)₍ₘ₎^{0.80}
where
(m) is the lighting metric being evaluated (luminous flux, luminous intensity, illuminance, luminance or luminous exitance)
P=the photopic lighting quantity (the standard for all lighting metrics)
(S/P)=the scotopic to photopic ratio of the light source.

14. A method for enabling selection of a lighting system, comprising:
receiving an identification of a plurality of baseline components of a baseline lighting system;
calculating estimates of performance characteristics of the baseline lighting system based on specified performance characteristics of the identified baseline components;
wherein the estimates of performance characteristics are calculated using at least one or both of photopic photometry and equivalent visual efficiency (EVE) algorithms;
determining a series of alternative lighting systems based on the estimates of performance characteristics of the baseline lighting system, each alternative lighting system including a plurality of mutually compatible components obtained from a database specifying performance characteristics for a plurality of components including the mutually compatible components;
wherein determining the series of alternative lighting systems includes calculating light output of combinations of the plurality of components using at least one or both of photopic photometry and equivalent visual efficiency (EVE) algorithms and comparing the calculation to the estimates of performance characteristics of the baseline system; and
enabling the selection of the lighting system from the series of alternative lighting systems.

15. The method of claim 14, wherein the baseline lighting system includes one or more of a controller, a ballast/driver, a lamp, a luminaire, and a combination device.

16. The method of claim 15, wherein the baseline lighting system is one of an existing lighting system targeted for replacement, a new lighting system design, or a hybrid light system including at least one lighting fixture for replacement and at least one new lighting fixture design.

17. The method of claim 14, wherein enabling the selection further comprises:
presenting the series of alternative lighting systems;
wherein presenting includes one or both of displaying the series of alternative lighting systems on a display screen and printing the series of alternative lighting systems to a visual medium.

18. The method of claim 14, wherein the series of alternative lighting systems are presented hierarchically based on at least one of energy usage, economic criteria, and rated life.

19. The method of claim 14, further comprising receiving a wiring scheme and/or switching scheme of the baseline components of the baseline lighting system.

20. The method of claim 19, further comprising receiving input describing a physical condition of the baseline components of the baseline lighting system.

21. The method of claim 20, wherein the physical condition of the baseline components includes one or more of luminaire housing geometry, luminaire interior height, lens cleanliness, lens condition, configuration of louvers.

22. The method of claim 14, wherein the series of alternative light systems is determined based on a calculation that produces light output generally equivalent to the baseline lighting system.

23. The method of claim 14, wherein the EVE lighting metrics are defined by the equation
EVE₍ₘ₎=P₍ₘ₎×(S/P)₍ₘ₎^{0.80}
where
(m) is the lighting metric being evaluated (luminous flux, luminous intensity, illuminance, luminance or luminous exitance)
P=the photopic lighting quantity (the standard for all lighting metrics)
(S/P)=the scotopic to photopic ratio of the light source.

24. A method for offering to a user a service for selecting a lighting system, comprising:
allowing the user access to the service, wherein the service accepts inputs from the user including identification of one or more baseline components of a baseline lighting system;
whereupon receiving inputs from the user, the service performs the steps of
calculating estimates of performance characteristics of the baseline lighting system based on performance characteristics of the identified baseline components specified in a database accessible to the service, and
determining a series of alternative lighting systems based on the estimates of performance characteristics of the baseline lighting system, each alternative lighting system including a plurality of mutually compatible components obtained from a database specifying performance characteristics for a plurality of components including the mutually compatible components; and
presenting at least a portion of the series of alternative lighting systems to the user;
allowing the user to select the lighting system from the at least a portion of the series of alternative lighting systems presented to the user; and
generating a specification including the mutually compatible components for the selected lighting system for use by the user.

25. The method of claim 24, further comprising:
allowing the user to purchase the mutually compatible components of the generated specification via the service.

26. The method of claim 24, further comprising:
allowing the user to purchase one or more combinations of the mutually compatible components of the generated specification via the service.

27. A method for enabling selection of a final lighting system, comprising:
receiving an identification of a plurality of components usable in an initial lighting system;
calculating estimates of performance characteristics of the initial lighting system based on specified performance characteristics of the identified components;
determining a series of alternative lighting systems based on the estimates of performance characteristics of the lighting system, each alternative lighting system including a plurality of mutually compatible components obtained from a database specifying performance characteristics for a plurality of components including the mutually compatible components; and
enabling the selection of the final lighting system from the series of alternative lighting systems.

28. The method of claim 27, wherein the initial lighting system includes one or more of a controller, a ballast/driver, a lamp, a luminaire, and a combination device.
